(19) United States
(12) Patent Application Publication
(10) Pub. No.: US 2013/0203526 A1
(43) Pub. Date: Aug. 8, 2013

(54) GOLF SWING ANALYSIS WITH PHYSICAL AND SKILL DEFICIT CORRECTION METHOD

(71) Applicants: Christopher T. Finn, Durham, NC (US); Kevin W. Poplawski, Atlanta, GA (US)

(72) Inventors: Christopher T. Finn, Durham, NC (US); Kevin W. Poplawski, Atlanta, GA (US)

(73) Assignee: New Kinetic Solutions, LLC

(21) Appl. No.: 13/364,373

(22) Filed: Feb. 2, 2012

(51) Int. Cl. A63B 69/36; G06F 19/00

(52) U.S. Cl. 473/409; 700/91

(57) ABSTRACT

The present invention relates for a golfer's swing training system for the improvement in playing a game of golf. The method observes and corrects a golfer's swing by first correcting any physical deficiency and then correcting faults to the golfer's swing.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to training for the game of golf. In particular, the present invention relates to a system for golf swing analysis and determination of golf swing problems related to swing fault, physical fault, or both and directing the golfer to corrective exercising and/or corrective golf skills drills.

2. Description of Related Art

The training of the golfer to improve his game is as old as the game itself. Originally, the only method for training was to hire a golf pro that would watch and give training based on observation and personal opinion. The invention of easy to use and inexpensive video cameras has introduced the use of the video camera to record an action and then analyze the swing even frame by frame to determine faults. Over the years, several patents have been issued for methods which analyze golf swing by using video.

Essentially, these training methods all involve analyzing the movement of the body during the swing movement and trying to train the individual to copy more productive swing mechanics. Generally, points are taken from the video of the golfer's swing and over time attempted to bring the swing back into a generally recognized alignment. However, like any sport, golf is a physical activity and no amount of swing activity training will improve some golf skills. A more comprehensive golf program is needed which takes all aspects of golf into consideration.

### BRIEF SUMMARY OF THE INVENTION

The present invention relates to the discovery that swing analysis in combination with physical skill analysis can train the golfer to improve his game more than previous training systems and methods. It relies on the discovery that if an individual does not possess certain physical skills, the individual cannot correct a swing fault, and therefore physical faults need to be corrected prior to correcting swing form faults.

Accordingly, in one embodiment of the present invention there is a system for improving the game of golf for an individual comprising a computer golf analysis and training program comprising:
a) a set of rules for golf swing for a proper golf swing form in resident memory on the computer when the individual is viewed down the line;
b) a set of rules for golf swing for a proper golf swing form in resident memory on the computer when the individual is viewed head on;
c) a set of rules for golf physical skills for the individual to have the physical skills to accomplish proper golf swing form both viewed down the line and viewed head on in resident memory on a computer;
d) a logic system in resident memory on the computer for comparing the down the line and head on swing of the individual to the set of rules for swing form and physical skills;
e) a set of rules in resident memory on the computer for analyzing the differences between the individual's swing form and the physical skills and determining which differences are due to a swing form fault and which are due to a physical skills fault of the individual;
f) a logic system on the computer for assigning one or more corrective exercises with the individual to correct physical faults, the exercises having a pass or fail criteria for having corrected faults; and
g) a logic system on the computer for assigning golf training to the individual for correcting swing form faults.

In yet another embodiment the present invention relates to a method of correcting the swing of an individual engaged in the game of golf utilizing a golf computer analysis and training program utilizing the system above comprising:
a) observe the individual swinging a golf club in both a head on and down the line view and determine any golf swing form faults;
b) test the individual for possession of the physical skill associated with performing any determined form faults;
c) if a physical skill is not possessed by the individual, train the individual until the individual possess the physical skill;
d) retest the individual for the golf swing form fault; and
e) if the golf swing fault remains after the individual possesses the physical skill, train the individual to obtain the proper form.

### BRIEF DESCRIPTION OF THE DRAWINGS

FIG. 1 is a relationship chart of the golf trainer, golfer, and the system of the present invention.

FIG. 2 is a flow chart of the use of the present system.

FIG. 3 is a relationship analysis chart of the present system and method.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “individual” refers to a golfer in need of golf game improvement by swing analysis and correction to determine how to improve their game of golf. The present invention combines not just the swing form itself but the physical ability or skill of the individual as well as the mechanics of the swing. Use of both the system and method end up making a change in the golfer's game by altering physical skills and swing form skills.

As used herein the term “golf analysis” refers to a system of the invention for use with or without the aide of an instructor which compares the golfer's swing form to predetermined criteria i.e. a set of rules, for a proper swing form. This can be done by an instructor or in one embodiment, by use of a video camera in combination with an instructor or a computer system analyzing the swing of the golfer compared to the set of rules. Then differences between the golfer's swing and the set of rules form a proper swing can be determined. Improper swing can be determined by video or personal observation, viewing “head on” (facing golfer) and in combination with a view “down the line” i.e. from the behind the golfer.

The objective is to determine variations from proper swing form so that upon correction, the golfer's game will be improved. Golf swing form of an individual golfer cannot be improved in golfers whose physical skill is lacking and the failure of previous systems has been the inability to do anything but attempt to correct swing form even when the individual does not possess the skill to perform a proper golf swing form. Accordingly, there is also an associated “physical skills analysis” which determines if the golfer has the physical capability to perform a proper swing. Once corrected, the form can also be corrected. Therefore, the system not only includes swing form training of the golfer, but first determines what physical skills, if any, are lacking by the golfer and corrects those before attempting to correct the golfer's swing form.

As used herein the term “swing form skills” refers to the form of the individual's mechanical golf swing. It includes those things or activities involved in a proper swing including grip, where to hold the club, body position, body movement, and the like which are determined by the ability of the individual to utilize proper motion. The swing form rules determine occurrences of activities which indicate form is incorrect. The form is analyzed in both down the line and head on swing observation either by an instructor or by a computer and camera analyzing the swing.

Examples include: down the line swing analysis of early extension, loss of posture, loss of spine angle over 3 lines (ear to greater trochanter, greater trochanter to lateral knee and lateral femoral condyle to lateral malleolus), over the top (line up shaft angle of club during address and second line down line of shaft when humerus is parallel to the ground wherein a problem if the club comes on top of these two lines, flat shoulder plane (if line of shoulders at top of backswing points more than 4 to 6 feet away from the ball), S-posture (line drawn up the posterior border of golfer from buttocks to head), C-posture (line drawn up the posterior border of golfer from buttocks to head), and “chicken winging”.

Examples of head on swing analysis include: sway (from trail lateral malleolus to trail hip greater trochanter, slide (from lead lateral malleolus straight up 90 degrees), Reverse spine angle (line from center of head to belt buckle), hang back, and casting/early release/scooping problems.

As used herein the term “physical skills” refers to the individual's physical ability to perform a particular physical task specifically proper swing form. As an analogy, while picking up something heavy properly from the ground using proper form is a skill, the amount of weight one could pick up using the proper form is a physical skill. Likewise, the strength, flexibility, and the like of various muscles and muscle groups will determine the success of the swing regardless of how good the individual's form of the swing is.

Upon completing the down the line and head on swing analysis, the system provides various physical tests for the golfer to perform which relate to each problem in swing form. One or more are utilized for each fault encountered in the initial analysis. If the golfer can perform all the physical tests (i.e. pass the test) properly for a given swing fault then the fault is in form alone and classical form correction of the swing can begin. If one or more of the physical tests is not passed, then the golfer is trained to correct the physical fault by use of exercise, weight training, and the like until the tests can be passed. If this corrects the swing fault, the system has completed this correction; if the swing fault remains after physical corrections, then the fault was both physical and form and then form can be corrected as noted above.

As used herein the term “computer” refers to any digital storage or processing such as a personal computer, server, web site, server with an internet connection, PDA, net book, phone, combination of these, or the like that has digital processing power for achieving the uploading of digital information and processing a logic system of the present invention. In one embodiment the golfer/instructor uses a PDA or personal computer with the program, on a server or the internet. Resident memory is the memory of any of the components comprising the computer.

As used herein an “analysis and training program” refers to the process of a trainer utilizing the present invention system to observe and categorize, or aide and correct and train in the swing form and physical attributes of the individual as it relates to the golf swing. There are two components being analyzed in the present invention analysis. The swing skills and the physical skills to perform the swing skills. Each of these two factors determine the outcome in attempting to train the individual to improve their golf game by improving their swing. The present invention involves setting up a set of “rules” for both the swing skills and the physical skills. One skilled in the art can determine the list of skills deemed important and can modify the skill sets as needed for individuals and as the system is refined in view of this disclosure. Examples of both are found in the specification. Those skill sets are entered into the computer for later comparison. They can be entered into the computer by, for example, an instructor observing the individual and making a determination based on a list from the computer or for example videoing the individual and having a logic program compare the video of the individual in form and physical skill set to determine the form and skills of the individual golfer. The computer system can provide the user of the exercises to test for physical fault and to correct the physical fault and to indicate what swing form issues are to be tested. The system of the present invention allows an instructor or the like to analyze the swing and use the system to aid or guide the testing of the problem causing the fault(s), to train the golfer for correction, and determine the golfer has corrected the faults.

As used herein a “logic system in the computer for comparing a golf swing of the individual to a set of rules for swing form and physical skill” refers to the computer comparing the set of rules to the actual swing of the individual. This can be done by the computer or by an instructor looking at the swing (or a recording of the swing) and looking for particular details on the system. One skilled in the art could program a computer or use an instructor in view of the disclosure herein.

As used herein a “logic system in the computer for analyzing the differences between the individual's swing and the rules” refers to then taking the comparison and determining the differences which are to be corrected and which are due to a swing form fault and which are due to physical ability to perform the swing properly.

The “logic system on the computer for assigning golf training to the individual for correcting swing form faults” refers to the computer assigning drills to correct those faults that are due entirely to the form of the individual's swing (either from a head on view or down the line view). Therefore where the swing is incorrect but performable by the individual, swing fault correction drills or training will be assigned by the computer system until the swing form faults are corrected.

The “logic system on the computer progressing through one or more corrective exercises with the individual, the exercises having a pass or fail criteria, for correcting physical skill faults” refers to assigning exercises by the individual to build up physical skill for one or more items the system has discovered is a physical skill deficit. For example, if the arms are just not strong enough appropriate arm strength training can be done. For example, if the lead hip lacks appropriate internal rotation then training can be done to correct. The corrective exercises will have a predetermined pass or fail criteria. That is, certain things that the individual must be able to do to demonstrate that the individual has acquired the physical strength/skill necessary. In addition particular items may also have a fail other than just not being able to do a particular item. For example, only being able to do a particular item may constitute a fail and require the individual to train the physical strength further. Each problem may have one or more exercises to be able to correct the physical strength, but one skilled in the art in view of this disclosure can create the exercises in addition to the examples disclosed in the present invention.

Accordingly, the individual utilizing the present invention will progress through both form correction and physical strength flexibility and firing patterns correction controlled by the computer in such a manner that the golf swing is corrected which, of course, improves the individual's golf game. The system can be used repeatedly to measure the progress of the individual or to just check that swing correction is maintained over time. An instructor can be utilized but where a camera is utilized an individual may be able to utilize the system without the instructor being involved, e.g. the user films (digitally) the swing head on and down the line and feeds it to the systems which makes the necessary analysis and proposes the necessary corrective steps to the individual golfer.

The computer has code embodied therein for causing the system to perform one or more or all the steps associated with the system stems.

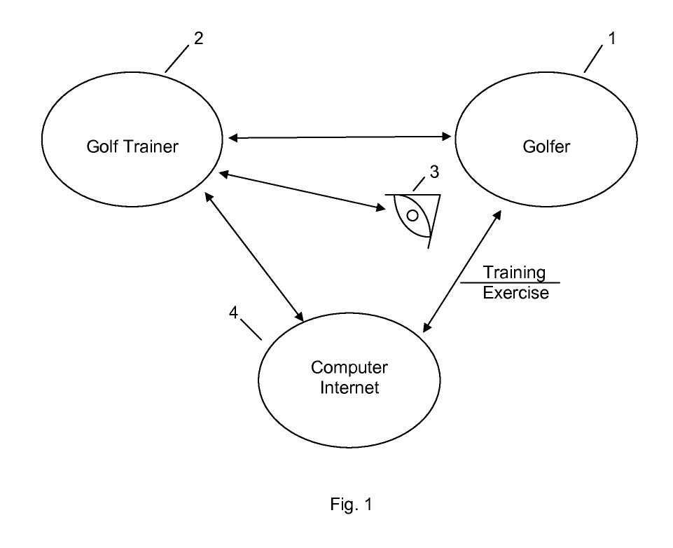

Now referring to the drawings, FIG. 1 is a schematic relationship between the golfer (individual), a golf trainer or pro (instructor), and a computer having the system in resident memory. In this figure golfer 1 has a relationship with golf trainer 2. In most cases the golfer has engaged a golf instructor for the purpose of improving the golfer's golf game primarily by improving the swing of the golfer. The trainer 2 views 3 the golfer 1 as the golfer swings a club and uses the input from the system on computer 4 to enter the differences wherein the computer system analyzes the input from golf trainer 2 and gives training and or exercise to the golfer 1 depending if physical or swing form change is needed.

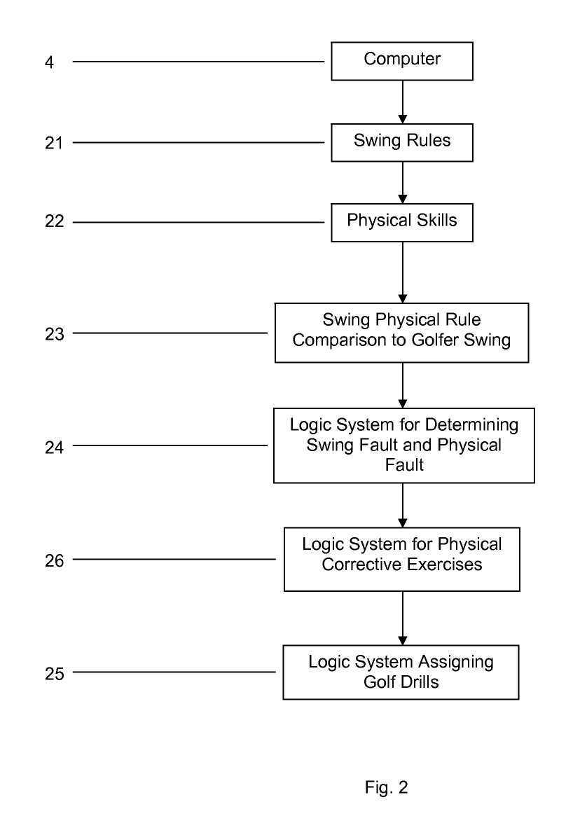

In FIG. 2 there is a flow chart of the system of the present invention. The computer 4 has loaded into it in resident memory the swing rules 21 and physical rules 22 necessary for a proper golf swing of the golfer. The swing 21 and physical 22 rules are compared to the golfer swing 23. After the comparison a logic system decides what swing faults are and what physical faults 24 are. Based on the results of the comparison, the logic system assigns either golf swing drills 25 or physical corrective exercises 26 which progress until the golfer has passed all tests for the physical skill.

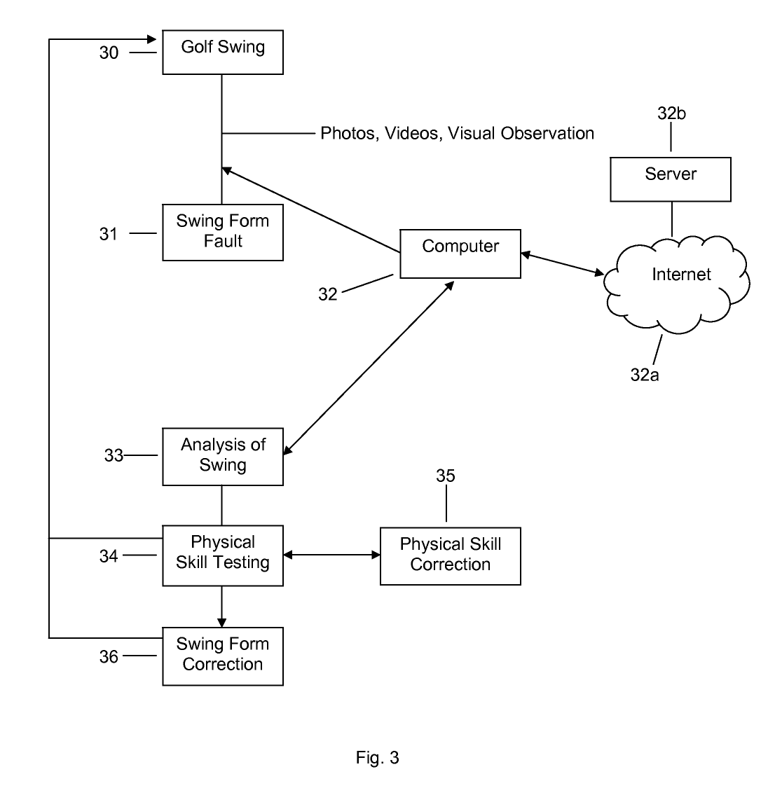

In FIG. 3 is a relationship chart of the computer and analysis when the computer is analyzing the golfer swing. In this relationship chart the golf swing 30 of the golfer is taken via pictures, visual observation or videoed and any swing fault 31 determined. The information fed to the computer 32. The computer 32 with the software in resident memory or on a server 32b in resident memory available on the internet 32a by computer 32, analyses the golf swing 33. The system first tests physical skills 34 and once passed, the form skills are corrected if the swing problem still exists. If the physical skills do not pass, the physical skills 35 are then corrected 35a with physical training and then the physical skills retested 34 until passed and the swing form 36 can be tested and corrected if necessary before reanalyzing the entire swing.

Following are examples of physical exercises and swing training data which can be utilized by a computer system.

### EXAMPLES

| | | | | | Physical | |
|---|---|---|---|---|---|---|
| | | | SCREEN | Further | Solution | |
| Importance | LINE | RESULT | RESULT | Insight | Decision Tree | Skill Solutions |
| 3 | Sway (from | Hip | Dissociation | Fail | Corrective | |
| | trail lateral | crosses | | | Exercises | |
| | malleolus to | line | | | Core/dissociation | |
| | trail hip | | Dissociation | Pass | Go to Single | |
| | greater | | | | Leg Squat | |
| | trochanter) | | Single Leg | Early Flexion | Gluteus | |
| | | | Squat Fail | | Maximus | |
| | | | | | Corrections | |
| | | | | No Early | Go to | |
| | | | | Flexion | Trendelenburg | |
| | | | | Trendelenburg | Gluteus | |
| | | | | | Medius | |
| | | | | | Corrections | |
| | | | | No | Go to Medial | |
| | | | | Trendelenburg | Knee | |
| | | | | Medial Knee | Gluteus | |
| | | | | or Loss of | Medius/Balance | |
| | | | | balance | Corrections | |
| | | | | No Medial | Go to Lead Hip | |
| | | | | Knee or Loss | ER | |
| | | | | of balance | | |
| | | | Single Leg | Pass | Go to Lead Hip | |
| | | | Squat | | ER | |
| | | | Lead Hip | Less than 60 | Hip ER | |
| | | | ER | degrees | Stretching | |
| | | | | Greater than | Go to Trail Hip | |
| | | | | or = 60 | IR | |
| | | | | degrees | | |
| | | | Trail Hip | Less than 60 | Hip IR | |
| | | | IR | degrees | Stretching | |
| | | | | Greater than | Go to True | |
| | | | | or = 60 | Trunk Rotation | |
| | | | | degrees | | |
| | | | True | Less than 45 | Trunk Rotation | |
| | | | Trunk | degrees | Corrections | |
| | | | Rotation | Greater than | Go to Sway | Sway Drills |
| | | | | or = 45 | Drills | |
| | | | | degrees | | |
| | | Hip does | Not problem | | | |
| | | not cross | | | | |
| 4 | Slide (from | Hip | Dissociation | Fail | Corrective | |
| | lead lateral | crosses | | | Exercises | |
| | malleolus | line | | | Core/dissociation | |
| | straight up 90 | | Dissociation | Pass | Go to Single | |
| | deg) | | | | Leg Squat | |
| | | | Single Leg | Early Flexion | Gluteus | |
| | | | Squat Fail | | Maximus | |
| | | | | | Corrections | |
| | | | | No Early | Go to | |
| | | | | Flexion | Trendelenburg | |
| | | | | Trendelenburg | Gluteus | |
| | | | | | Medius | |
| | | | | | Corrections | |
| | | | | No | Go to Medial | |
| | | | | Trendelenburg | Knee | |
| | | | | Medial Knee | Gluteus | |
| | | | | or loss of | Medius/Balance | |
| | | | | balance | Corrections | |
| | | | | No Medial | Go to Lead Hip | |
| | | | | Knee or loss | IR | |
| | | | | of balance | | |
| | | | Single Leg | Pass | Go to Lead Hip | |
| | | | Squat | | IR | |
| | | | Lead Hip | Less than 60 | Hip IR | |
| | | | IR | degrees | Stretching | |
| | | | | Greater than | Go to Trail Hip | |
| | | | | or = 60 | ER | |
| | | | | degrees | | |
| | | | Trail Hip | Less than 60 | Hip ER | |
| | | | ER | degrees | Stretching | |
| | | | | Greater than | Go to True | |
| | | | | or = 60 | Trunk Rotation | |
| | | | | degrees | | |
| | | | True | Less than 45 | Trunk Rotation | |
| | | | Trunk | degrees | Corrections | |
| | | | Rotation | Greater than | Go to Slide | Slide Drills |
| | | | | or = 45 | Drills | |
| | | | | degrees | | |
| | | Hip does | Not problem | | | |
| | | not cross | | | | |
| 1 | Reverse Spine | Bottom | Dissociation | Fail | Corrective | |
| | Angle (line | of Line | | | Exercises | |
| | from center of | towards | | | Core/dissociation | |
| | head to belt | target | Dissociation | Pass | Go to Single | |
| | buckle) | | | | Leg Squat | |
| | | | Single Leg | Early Flexion | Gluteus | |
| | | | Squat Fail | | Maximus | |
| | | | | | Corrections | |
| | | | | No Early | Go to | |
| | | | | Flexion | Trendelenburg | |
| | | | | Trendelenburg | Gluteus | |
| | | | | | Medius | |
| | | | | | Corrections | |
| | | | | No | Go to Medial | |
| | | | | Trendelenburg | Knee | |
| | | | | Medial Knee | Gluteus | |
| | | | | or loss of | Medius/Balance | |
| | | | | balance | Corrections | |
| | | | | No Medial | Go to Lead Hip | |
| | | | | Knee or loss | ER | |
| | | | | of balance | | |
| | | | Single Leg | Pass | Go to Lead Hip | |
| | | | Squat | | ER | |
| | | | Lead Hip | Less than 60 | Hip ER | |
| | | | ER | degrees | Stretching | |
| | | | | Greater than | Go to Trail Hip | |
| | | | | or = 60 | IR | |
| | | | | degrees | | |
| | | | Trail Hip | Less than 60 | Hip IR | |
| | | | IR | degrees | Stretching | |
| | | | | Greater than | Go to True | |
| | | | | or = 60 | Trunk Rotation | |
| | | | | degrees | | |
| | | | True | Less than 45 | Trunk Rotation | |
| | | | Trunk | degrees | Corrections | |
| | | | Rotation | Greater than | Go to Rev. | Rev. Spine |
| | | | | or = 45 | Spine Angle | angle Drills |
| | | | | degrees | Drills | |
| | | Bottom | Not a problem | | | |
| | | of Live | | | | |
| | | away | | | | |
| | | from | | | | |
| | | target | | | | |
| 2 | Hang Back | Hip does | Single Leg | Early Flexion | Gluteus | |
| | | not | Squat Fail | | Maximus | |
| | | touch | | | Corrections | |
| | | line | | No Early | Go to | |
| | | (Lead | | Flexion | Trendelenburg | |
| | | lateral | | Trendelenburg | Gluteus | |
| | | malleolus | | | Medius | |
| | | straight | | | Corrections | |
| | | up 90 | | No | Go to Medial | |
| | | degrees) | | Trendelenburg | Knee | |
| | | | | Medial Knee | Gluteus | |
| | | | | or loss of | Medius/Balance | |
| | | | | balance | Corrections | |
| | | | | No Medial | Go to Lead Hip | |
| | | | | Knee or loss | IR | |
| | | | | of balance | | |
| | | | Lead Hip | Less than 60 | Hip IR | |
| | | | IR | degrees | Stretching | |
| | | | | Greater than | Go to Trail Hip | |
| | | | | or = 60 | ER | |
| | | | | degrees | | |
| | | | Trail Hip | Less than 60 | Hip ER | |
| | | | ER | degrees | Stretching | |
| | | | | Greater than | Go to | |
| | | | | or = 60 | Dissociation | |
| | | | | degrees | | |
| | | | Dissociation | Fail | Corrective | |
| | | | | | Exercises | |
| | | | | | Core/dissociation | |
| | | | Dissociation | Pass | Go to Hang | Hang Back |
| | | | | | Back Drills | Drills |
| | | Hip does | Not a Problem | | | |
| | | touch | | | | |
| | | line or | | | | |
| | | cross it | | | | |
| | | (Lead | | | | |
| | | lateral | | | | |
| | | malleolus | | | | |
| | | straight | | | | |
| | | up 90 | | | | |
| | | degrees) | | | | |
| 5 | Casting/Early | Angle | Dissociation | Fail | Corrective | |
| | Release/Scooping | from top | | | Exercises | |
| | | of | | | Core/dissociation | |
| | | backswing | Dissociation | Pass | Go to Single | |
| | | to arm | | | Leg Squat | |
| | | parallel | Single Leg | Early Flexion | Gluteus | |
| | | increases; | Squat Fail | | Maximus | |
| | | hands | | | Corrections | |
| | | cross | | No Early | Go to | |
| | | horizantol | | Flexion | Trendelenburg | |
| | | line | | Trendelenburg | Gluteus | |
| | | from | | | Medius | |
| | | hips | | | Corrections | |
| | | after | | No | Go to Medial | |
| | | club | | Trendelenburg | Knee | |
| | | head; no | | Medial Knee | Gluteus | |
| | | forward | | or loss of | Medius/Balance | |
| | | shaft | | balance | Corrections | |
| | | lean at | | No Medial | Go to Lead Hip | |
| | | impact. | | Knee or loss | IR | |
| | | | | of balance | | |
| | | | Single Leg | Pass | Go to Lead Hip | |
| | | | Squat | | IR | |
| | | | Lead Hip | Less than 60 | Hip IR | |
| | | | IR | degrees | Stretching | |
| | | | | Greater than | Go to Lead Hip | |
| | | | | or = 60 | ER | |
| | | | | degrees | | |
| | | | Lead Hip | Less than 60 | Hip ER | |
| | | | ER | degrees | Stretching | |
| | | | | Greater than | Go to Trail Hip | |
| | | | | or = 60 | IR | |
| | | | | degrees | | |
| | | | Trail Hip | Less than 60 | Hip IR | |
| | | | IR | degrees | Stretching | |
| | | | | Greater than | Go to Trail Hip | |
| | | | | or = 60 | ER | |
| | | | | degrees | | |
| | | | Trail Hip | Less than 60 | Hip ER | |
| | | | ER | degrees | Stretching | |
| | | | | Greater than | Go to | casting/early |
| | | | | or = 60 | casting/early | release/scooping |
| | | | | degrees | release/scooping | Drills |
| | | | | | Drills | |

| | |
|---|---|
| Angle | Not a problem |
| from top | |
| of | |
| backswing | |
| to arm | |
| parallel | |
| decreases; | |
| hands | |
| cross | |
| horizantol | |
| line | |
| from | |
| hips | |
| before | |
| club | |
| head; | |
| forward | |
| shaft | |
| lean at | |
| impact. | |

| | | | | | | PROGRESSION |
|---|---|---|---|---|---|---|
| | | | | | | WHEN |
| | | | | SECOND | | FAULT |
| | | | | TEST/FURTHER | | PHYSICALLY |
| IMPORTANCE | LINE | RESULT | FIRST TEST | DETAIL | SOLUTION | CORRECTED |
| 1 | Early | Buttocks | OH Squat | Arms | Shoulder/scapular | |
| | Extension | off line | Fail | crossed pass | strength&ROM | |
| | Line (90 | | | Arms | Ankle ROM | |
| | degrees | | | Crossed fail | | |
| | straight | | OH Squat | Go to Dissociation | | |
| | up/down | | Pass | | | |
| | on | | Dissociation | Fail | Exercises | |
| | posterior | | | | Core/dissociation | |
| | most aspect | | Dissociation | Pass | Go to Lead Hip IR | |
| | of buttocks) | | Lead Hip | Less than 60 | Hip IR Stretching | |
| | | | IR | degrees | | |
| | | | | Greater than | Go to Lead Hip ER | |
| | | | | or = 60 | | |
| | | | | degrees | | |
| | | | Lead Hip | Less than 60 | Hip ER Stretching | |
| | | | ER | degrees | | |
| | | | | Greater than | Go to Trail Hip IR | |
| | | | | or = 60 | | |
| | | | | degrees | | |
| | | | Trail Hip IR | Less than 60 | Hip IR Stretching | |
| | | | | degrees | | |
| | | | | Greater than | Go to Trail Hip ER | |
| | | | | or = 60 | | |
| | | | | degrees | | |
| | | | Trail Hip | Less than 60 | Hip ER stetching | |
| | | | ER | degrees | | |
| | | | | Greater than | Go to Early | Early |
| | | | | or = 60 | extension Drills | extension |
| | | | | degrees | | Drills |
| | | Buttocks | Not a Problem | | | |
| | | on line | | | | |
| 2 | Loss of | Off Line | OH Squat | Arms | Shoulder/scapular | |
| | Posture (spine | | Fail | crossed pass | strength&ROM | |
| | angle) 3 | | | Arms | Ankle ROM | |
| | lines from | | | crossed fail | | |
| | ear to | | OH Squat | Go to Dissociation | | |
| | greater | | Pass | | | |
| | trochanter, | | Dissociation | Fail | Exercises | |
| | greater | | | | Core/dissociation | |
| | trochanter | | Dissociation | Pass | Go to Single Leg | |
| | to lateral | | | | Squat | |
| | knee, | | Single Leg | Early Flexion | Gluteus Maximus | |
| | lateral knee | | Squat Fail | | Corrections | |
| | to lateral | | | No Early | Go to | |
| | malleolus | | | Flexion | Trendelenburg | |
| | | | | Trendelenburg | Gluteus Medius | |
| | | | | | Corrections | |
| | | | | No | Go to Medial Knee | |
| | | | | Trendelenburg | | |
| | | | | Medial Knee | Hip | |
| | | | | or Loss of | Stabilization/Balance | |
| | | | | balance | Corrections | |
| | | | | No Medial | go to Lead Hip ER | |
| | | | | Knee or Loss | | |
| | | | | of balance | | |
| | | | Single Leg | Go to Lead Hip ER | | |
| | | | Squat Pass | | | |
| | | | Lead Hip | Less than 60 | Hip ER Stretching | |
| | | | ER | degrees | | |
| | | | | Greater than | Go to Trail Hip IR | |
| | | | | or = 60 | | |
| | | | | degrees | | |
| | | | Trail Hip IR | Less than 60 | Hip IR Stretching | |
| | | | | degrees | | |
| | | | | Greater than | Go to True Trunk | |
| | | | | or = 60 | Rotation | |
| | | | | degrees | | |
| | | | True Trunk | Less than 45 | Trunk Rotation | |
| | | | Rotation | degrees | Stretching | |
| | | | | Greater than | Go to loss of | Loss of |
| | | | | or = 45 | posture Drills | posture |
| | | | | degrees | | Drills |
| | | On Line | Not a Problem | | | |
| 3 | Over the | Out of | Dissociation | NONE | Corrective | |
| | Top (line up | Slot | fail | | Exercises | |
| | shaft angle | | | | Core/dissociation | |
| | during | | Dissociation | NONE | Go to Single Leg | |
| | address and | | Pass | | Squat | |
| | second line | | Single Leg | Early Flexion | Gluteus Maximus | |
| | down line | | Squat | | Corrections | |
| | of shaft | | | No Early | Go to | |
| | when | | | Flexion | Trendelenburg | |
| | humerus is | | | Trendelenburg | Gluteus Medius | |
| | parallel to | | | | Corrections | |
| | ground. | | | No | Go to Medial Knee | |
| | Then if club | | | Trendelenburg | | |
| | comes on | | | Medial Knee | Hip | |
| | top of these | | | or Loss of | Stabilization/Balance | |
| | two lines. | | | balance | Corrections | |
| | | | | No Medial | Go to Over the | Over the |
| | | | | Knee or Loss | top Drills | Top Drills |
| | | | | of balance | | |
| | | In Slot | Not Problem | | | |
| 4 | Flat | Flat | Dissociation | Fail | Corrective | |
| | shoulder | Shoulders | | | Exercises | |
| | plane (if | | | | Core/Dissociation | |
| | line of | | Dissociation | Pass | Go to Trunk | |
| | shoulders at | | | | Rotation | |
| | top of | | True Trunk | Less than 45 | Trunk Rotation | |
| | backswing | | Rot. Fail | degrees | Corrections | |
| | points more | | True Trunk | Greater than | Go to Scapular | |
| | than 4-6 | | Rot. Pass | or = 45 | Observation | |
| | feet away | | | degrees | | |
| | from the | | Scapular | Fail | Scapular/shoulder | |
| | ball, | | Observation | | strength&ROM | |
| | potentially | | Scapular | Pass | Go to Lead Hip ER | |
| | could | | Observation | | | |
| | standardize | | Lead Hip | Less than 60 | Lead Hip ER | |
| | angle?) | | ER | degrees | Stretching | |
| | | | | Greater than | Go to Trail Hip IR | |
| | | | | or = 60 | | |
| | | | | degrees | | |
| | | | Trail Hip IR | Less than 60 | Trail Hip IR | |
| | | | | degrees | Stretching | |
| | | | | Greater than | Go to Flat | Flat |
| | | | | or = 60 | shoulder plane | shoulder |
| | | | | degrees | Drills | plane Drills |
| | | No Flat | NOT PROBLEM | | | |
| | | Shoulders | | | | |
| 5 | S-Posture | S-line | Pelvic Tilt | Pass | Go to Single Leg | |
| | (line drawn | back | | | Squat | |
| | up the | border | Pelvic Tilt | Fail | Core Corrections | |
| | posterior | | Single Leg | Early Flexion | Gluteus Maximus | |
| | border of | | Squat | | corrections | |
| | golfer from | | | No Early | Go to S-posture | S-Posture |
| | buttocks to | | | Flexion | Drills | Drills |
| | head.) | No S- | NOT PROBLEM | | | |
| | | line back | | | | |
| | | border | | | | |
| 6 | C-Posture | C-line | Pelvic Tilts | Pass | Go to Scapular | |
| | (line drawn | back | | | Observation | |
| | up the | border | Pelvic Tilt | Fail | Core Corrections | |
| | posterior | | Scapular | Fail | Scapular/shoulder | |
| | border of | | Observation | | strength&ROM | |
| | golfer from | | Scapular | Pass | Go to Single Leg | |
| | buttocks to | | Observation | | Squat | |
| | head.) | | Single Leg | Early Flexion | Gluteus Maximus | |
| | | | Squat | | Corrections | |
| | | | | No Early | Go to C-Posture | c-posture |
| | | | | Flexion | Drills | drills |
| | | No C- | NOT PROBLEM | | | |
| | | Line | | | | |
| | | along | | | | |
| | | back | | | | |
| 7 | Chicken | elbow | Scapular | Fail | Scapular/shoulder | |
| | Winging | before | Observation | | strength&ROM | |
| | | club on | Scapular | Pass | Ask for ER test | |
| | | follow | Observation | | | |
| | | through | ER test | Fail | ER corrections | |
| | | | ER Test | pass | Go to chicken | Chicken |
| | | | | | winging skill drills | Wing skill |
| | | | | | | drills |

| | |
|---|---|
| Club | Not a Problem |
| before | |
| elbow | |
| on | |
| follow | |
| through | |

### Scapular Observation

Fail: 1) borders of right and left scapula do NOT move symmetrically

2) Medial border protrudes with hands on hips

3) the inferior pole of scapula sticks out at extreme end range (anterior tilting)

Pass: None of the above are evident.

If needed: 90/90 test

Fail: radius angle is less than spine angle or there is discrepancy side to side.
Pass: angle is equal side to side and at least=to spine angle in both positions.

### Overhead (OH) Squat

Fail: 1) Dowel/club goes in front of feet during squat

2) one side is more leaned to than the other

3) heels come off ground

4) spine angle is not parallel to tibia(shin) angle

5) Femur does not cross parallel

If fail OH squat then analyze crossed arm
Fail: 1) femur does not cross parallel

2) Spine angle is more flexed than tibia angle

3) heels come off ground

4) Lean to one side more than the other

Pass: None of the above exists

### Single Leg Squat (SLS)

Fail: 1) early flexion of trunk (trunk flexes excessively and early during the squat)

2) trendelenburg (hip of non-weight bearing side drops, hips no longer level)

3) medial knee (knee translates more medial than it starts during the squat)

4) loss of balance (person is unable to complete 3 squats without losing balance or corkscrews—arms flail and trunk all over the place trying to keep balance)

Pass: None of the above exist.

### Dissociation

Fail: Shoulders and trunk move while person is instructed to move only one or the other.
Pass: Shoulders and trunk are able to be moved independent of each other.

### True Trunk Rotation

Fail: 1) shoulders turn <45 degrees

2) rotation to either side is not equal to the other

Pass: shoulders turn=or >45 degrees

### Pelvic Tilts

Fail: 1) Unequal range of motion anterior/posterior

2) Shakiness while posterior tilting

3) Movement in legs or trunk during tilt as an attempt to complete the motion.

4) Unable isolate hip movement

Pass: 1) Full and equal range of motion of hips anteriorly and posteriorly

2) None of the above in fail exist.

### Hip Internal/External Rotation (IR/ER)

### Scapular Strength

Level 1
Low row isometrics
Scapular retraction isometrics

Level 2
Serratus Anterior punches supine
Rows
Low Rows

Level 3
Lawnmower
Robber

Level 4
Prone Y-T-A

### Shoulder Strength

Level 1
External Rotation at side
Internal Rotation side

Level 2
External Rotation at 90 degrees abduction
Internal Rotation at 90 degrees abduction

Level 3
Eccentric external rotation at 90 degrees abduction
Eccentric internal rotation at 90 degrees abduction
Flexion raises
Abduction raises
Shrugs

Level 4
Plyometric throws with arm abducted to 90 degrees

### Shoulder ROM

Sleeper stretch (posterior capsule)

Pectoral doorway stretch (Pectoral)

External rotation doorway stretch (Anterior Capsule)

Latissimus doorway stretch (Inferior Capsule)

### Trunk Rotation Corrections

Level 1
Rib ripper stretch

Level 2
½ knee trunk rotations with dowel behind scapula
Latissimus doorway stretch

Level 3
Heisman (opposite trunk and hips)
Single leg stance hip rotations (stork turn)
Single leg stance trunk rotations (1 leg golf swing)
½ kneel with trunk rotations using dowel behind scapula

Level 4
½ kneel alternating punch rotations with resistance (dumbbell, resistance band, cable)
1 arm row with other arm on bench and rotate trunk (dumbbell, resistance band)
Abduction walk with opposite trunk turn (resistance band)
Plyometric medicine ball sideways tosses with trunk rotations between each toss. (medicine ball, second person, trampoline, wall, resistance band if no second person or trampoline or wall)

### Dissociation Exercises

Level 1
Pelvic Tilt progression (supine, quadruped, standing)

Level 2
Rib Ripper stretch
Knee rotations with shoulders supine

Level 3
Heisman (opposite trunk and hips)
Single leg stance hip rotations (stork turn)
Single leg stance trunk rotations (1 leg golf swing)
½ kneel with trunk rotations using dowel behind scapula

Level 4
½ kneel alternating punch rotations with resistance (dumbbell, resistance band, cable)
1 arm row with other arm on bench and rotate trunk (dumbbell, resistance band)
Abduction walk with opposite trunk turn (resistance band)
Plyometric medicine ball sideways tosses with trunk rotations between each toss. (medicine ball, second person, trampoline, wall, resistance band if no second person or trampoline or wall)

### Core Stability Exercises

Level 1
Pelvic tilt progression (supine, quadruped, standing)

Level 2
Sitting on physioball alternating UE and LE
Sitting on Physioball with same side UE and LE
Bridge with pelvic neutral (need to make sure not feeling in hamstring or back)
Bent knee lower abdominal crunches keeping pelvic neutral (no back strain)

Level 3
Plank 2 arm and 2 foot static
Bridge with no arm support in pelvic neutral
Plank with alternating foot taps (once can do bridge for 30 seconds with no back strain)

Level 4
Plank with alternating knee hikes
Plank with arms on inverted Bosu ball
Straight leg lowering in pelvic neutral
Diagonal rotations with band in ½ kneeling
Plyometric Power slams with dead medicine ball (if no ball use resistance band)
Plyometric Overhead throws with medicine ball (if no ball use resistance band)
Plyometric Sideways throwing rotations with medicine ball (if no ball use resistance band)

### Hip Stability Exercises

Level 1
Pelvic tilt progression (supine, quadruped, standing)

Level 2
Bridge with pelvic neutral (gluteus maximus)
Bridge with pelvic neutral and External rotation with resistance band (without if no band) (gluteus maximus/medius)
Monster walks with band (without if no band) (gluteus medius)
Fire hydrants with band (without if no band) (gluteus medius)

Level 3
Single leg stance gluteus medius hip hikes (gluteus medius)
Abduction walk with band (if no band then skip) (gluteus medius)
Single leg stance swing rotations with no hip drop (gluteus medius)
Squat with hip external rotation with band (without if no band) (gluteus maximus/medius)
Static Lunge with no medial knee or hip drop (dumbbells/resistance band/body weight) (gluteus maximus/medius)

Level 4
Walking lunge with no medial knee or hip drop (DB/band/bodyweight) (gluteus maximus/medius)
Abduction walk with butt burners (squat with hip external rotation between each step) with band but if no band then without band (gluteus maximus/medius)
Single leg Romanian Dead Lift with no hip drop or medial knee (gluteus maximus/medius)
Plyometric squat jumps with no medial knees (use band for first 2 sessions) (gluteus maximus/medius)
Plyometric 180 degree jumps with no medial knees (gluteus maximus/medius)
Plyometric lunge jumps with no medial knee or hip drop (gluteus maximus/medius)

### Hip Stretching

Internal Rotation
90/90 hip internal rotation stretch (if knee pain, joint replacement history or residual pain in knee go to alternate)
(Alternate IR stretch) Sitting in chair internal rotation stretch

External Rotation
Seated hip external rotation stretch (if too easy then go to next)
Pigeon Pose

Hamstring
Standing with heel on elevated surface

Hip Flexor/Quad
Prone 2 joint stretch (if too hard go to next)
Supine 2 joint stretch (if still too hard, go to next)
Sidelying 2 joint stretch
½ kneel runners stretch

### Ankle ROM

Stretch board with knee straight (if no stretch board go to runner stretch)
Stretch board with knee bent (if no stretch board go to runner stretch)
Gastrocnemius Runner stretch
Soleus Runner stretch
Search and Destroy on calf

### Balance Corrections

Level 1
Single leg stance eyes open (when can do for 20 seconds go to level 2)

Level 2 (when can do Both for 20 Seconds go to Level 3)
Single leg stance eyes closed
Single leg stance eyes open standing on unsteady surface

Level 3
Single leg stance eyes closed on unsteady surface
Single leg stance golf swings no arm support
Single leg stance hip turns with no arm support
Single leg stance heel touches with small ball

Level 4
Single leg stance bicep curls
Single leg stance medicine ball toss
Single leg heel touches on foam (progress to Bosu ball)

What is claimed is:

1. A system for improving the game of golf for an individual comprising a computer golf analysis and physical training program comprising:
a) a set of rules for golf swing for a proper golf swing form in resident memory on the computer when the individual is viewed down the line;
b) a set of rules for golf swing for a proper golf swing form in resident memory on the computer when the individual is viewed head on;
c) a set of rules for golf physical skills for the individual to have the physical skills to accomplish proper golf swing form both viewed down the line and viewed head on in resident memory on a computer;
d) a logic system in resident memory on the computer for comparing the down the line and head on swing of the individual to the set of rules for swing form and physical skills;
e) a set of rules in resident memory on the computer for analyzing the differences between the individual's swing form and the physical skills and determining which differences are due to a swing form fault and which are due to a physical skills fault of the individual;
f) a logic system on the computer for assigning one or more corrective exercises with the individual to correct physical faults, the exercises having a pass or fail criteria for having corrected faults; and
g) a logic system on the computer for assigning golf training to the individual for correcting swing form faults.

2. The system according to claim 1 further comprising repeatedly engaging the individual in the system to measure the change in the golf swing over time.

3. The system according to claim 1 wherein the golf swing is analyzed by an instructor utilizing the system to analyze the individual and provide training.

4. The system according to claim 1 wherein a computer readable medium has code embodied therein for causing the system to perform the steps associated with claim 1.

5. The system according to claim 1 wherein the pass/fail criteria are one or more predetermined physical movements of the individual which the individual can perform to pass or not perform to fail.

6. The system according to claim 6 wherein the predetermined form physical fault is selected from the group comprising, overhead squat, single leg squat, shoulder and trunk dissociation, trunk rotation, pelvic tilts and hip internal/external rotation.

7. The system according to claim 1 where a form fault is corrected by first determining if there are physical faults preventing the individual from performing the proper swing form and correcting the physical and then when there are no physical faults correcting the form of the swing.

8. The system according to claim 1 wherein the down the line swing form fault is selected from a list comprising early extension, loss of posture, over the top, flat shoulder plane, s-posture, c-posture and chicken winging.

9. The system according to claim 1 wherein the head on swing form fault is selected from a list comprising sway, slide, reverse spine angle, hang back, casting, early release and scooping.

10. The system according to claim 1 wherein once a form fault is of the individual is determined then the individual is tested for correct physical skills and if the individual has correct physical skills it is determined that the individuals sole problem is swing form.

11. The system according to claim 10 wherein the individual is alternatively tested for physical skills and trained to correct physical skills until the individual has the correct physical skill.

12. A method of improving the swing of an individual engaged in the game of golf utilizing a swing form analysis, physical skill analysis and a physical training program comprising:
a) observe the individual swinging a golf club in both a head on and down the line view and determine any golf swing form faults as compared to a set of rules for swing form;
b) test the individual for possession of the physical skill associated with performing any determined swing form faults;
c) if a physical skill is not possessed by the individual for correct swing form, train the individual until the individual possess the physical skill;
d) retest the individual for the golf swing form fault once the individual posses the physical skill; and
e) if the golf swing fault remains after the individual posses the physical skill train the individual to obtain the proper swing form.

13. The method according to claim 12 wherein exercises are used to correct physicals skills to improved at least one of scapular strength, shoulder strength, shoulder range of motion, trunk rotation, dissociation, core stability, hip stability hip range of motion, ankle range of motion, and balance.
